(19) United States
(12) Patent Application Publication
(10) Pub. No.: US 2026/0235359 A1
(43) Pub. Date: Aug. 13, 2026

(54) Electrode Drying Apparatus and Electrode Manufacturing System

(71) Applicant: SK On Co., Ltd., Seoul (KR)

(72) Inventors: Ji Yun YANG, Daejeon (KR); Dong Young JUNG, Daejeon (KR)

(21) Appl. No.: 19/533,780

(22) Filed: Feb. 9, 2026

(30) Foreign Application Priority Data
Feb. 11, 2025 (KR) 10-2025-0017100

(51) Int. Cl. F26B 21/33; F26B 13/10; H01M 4/04

(52) U.S. Cl. CPC F26B 21/33; F26B 13/108; H01M 4/0402; H01M 4/0471

(57) ABSTRACT

An electrode drying apparatus and an electrode manufacturing system are disclosed. According to one aspect of the present disclosure, there are provided an electrode drying apparatus comprising a drying chamber provided with an air supply duct and an exhaust duct, a transfer device configured to transfer a metal foil into the drying chamber, and a moisture supply device configured to supply moisture to the metal foil transferred into the drying chamber and an electrode manufacturing system comprising the same.

### CROSS-REFERENCE TO RELATED APPLICATION

The present application claims priority to and the benefit of Korean Patent Application No. 10-2025-0017100, filed on Feb. 11, 2025 in the Korean Intellectual Property Office, the entire disclosure of which is incorporated herein by reference.

### TECHNICAL FIELD

Embodiments of the present disclosure relate to an electrode drying apparatus and an electrode manufacturing system.

### BACKGROUND

A secondary battery is one of the energy storage devices which can be charged and discharged through electrochemical reactions. Secondary batteries may be used in various fields using electrical energy. For example, secondary batteries are widely used in the field of mobile devices such as mobile phones, notebooks, and tablets, and broader use is being explored in the field of transportation such as vehicles, aircraft, and ships. In addition, demand for secondary batteries is increasing in the field of energy storage systems (ESSs) for utilizing surplus power.

A secondary battery may be provided with a structure in which an electrode assembly is accommodated along with an electrolyte inside a case. The electrode assembly may be provided with a positive electrode and a negative electrode disposed with a separator interposed therebetween. The positive electrode and the negative electrode may be manufactured by applying a slurry prepared by mixing an active material, a binder, and a conductive material onto a metal foil, and then drying the slurry.

### SUMMARY

Some embodiments of the present disclosure may provide a battery manufacturing apparatus and an electrode manufacturing system.

In addition, some embodiments of the present disclosure may provide an electrode drying apparatus and an electrode manufacturing system capable of preventing overdrying of a slurry.

In addition, some embodiments of the present disclosure may provide an electrode drying apparatus and an electrode manufacturing system capable of minimizing slurry loss.

In addition, some embodiments of the present disclosure may provide an electrode drying apparatus and an electrode manufacturing system capable of improving work efficiency.

Some embodiments of the present disclosure may be widely applied in green technology fields such as electric vehicles, battery charging stations, and solar power generation and wind power generation utilizing batteries. In addition, some embodiments of the present disclosure may be used in eco-friendly electric vehicles and hybrid vehicles to suppress air pollution and greenhouse gas emissions and prevent climate change.

According to an aspect of the present disclosure, there is provided an electrode drying apparatus comprising a drying chamber provided with an air supply duct and an exhaust duct, a transfer device configured to transfer a metal foil into the drying chamber, and a moisture supply device configured to supply moisture to the metal foil transferred into the drying chamber.

In some embodiments, the moisture supply device may spray moisture onto the metal foil.

In some embodiments, the electrode drying apparatus may comprise a humidity sensor configured to sense the humidity inside the drying chamber.

In some embodiments, one or more of a moisture spray amount and a spray time of the moisture supply device may be adjusted according to the humidity inside the drying chamber.

According to another aspect of the present disclosure, there is provided an electrode drying apparatus comprising a drying chamber provided with an air supply duct and an exhaust duct, a transfer device configured to transfer a metal foil into the drying chamber, and a moisture supply device provided inside the air supply duct to supply moisture to air supplied into the drying chamber.

In some embodiments, the moisture supply device may spray moisture into the air supply duct.

In some embodiments, the electrode drying apparatus may comprise a humidity sensor configured to sense the humidity inside the drying chamber.

In some embodiments, the moisture supply device may adjust one or more of a moisture spray amount and a spray time according to the humidity inside the drying chamber.

In some embodiments, the air supply duct may comprise an upper air supply duct connected to an upper portion of the drying chamber and the moisture supply device may be provided in the upper air supply duct.

In some embodiments, the air supply duct may comprise a lower air supply duct connected to a lower portion of the drying chamber and the moisture supply device may be provided in the lower air supply duct.

In some embodiments, the air supply duct may comprise an upper air supply duct connected to an upper portion of the drying chamber and a lower air supply duct connected to a lower portion of the drying chamber and the moisture supply device may be provided in one or more of the upper air supply duct and the lower air supply duct.

According to still another aspect of the present disclosure, there is provided an electrode manufacturing system comprising the electrode drying apparatus and a die configured to apply a slurry onto the metal foil.

In some embodiments, the moisture supply device may supply moisture into the drying chamber before the die applies the slurry onto the metal foil.

In some embodiments, the die may apply the slurry onto the metal foil after moisture inside the drying chamber is saturated.

In some embodiments, a plurality of drying chambers may be disposed in a transfer direction of the metal foil.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic perspective view of a secondary battery according to one embodiment of the present disclosure;

FIG. 2 is a schematic perspective view of an electrode assembly according to one embodiment of the present disclosure;

FIG. 3 is a schematic view illustrating the electrode assembly in FIG. 2 being wound around a central axis;

FIG. 4 is a configuration view of an electrode drying apparatus and an electrode manufacturing system according to one embodiment of the present disclosure;

FIG. 5 is a partially enlarged view of an electrode drying apparatus and an electrode manufacturing system according to another embodiment of the present disclosure;

FIG. 6 is a flowchart showing an operation sequence of the electrode manufacturing system illustrated in FIG. 4;

FIG. 7 is a configuration view of an electrode drying apparatus and an electrode manufacturing system according to still another embodiment of the present disclosure;

FIG. 8 is a configuration view of an electrode drying apparatus and an electrode manufacturing system according to yet another embodiment of the present disclosure;

FIG. 9 is a flowchart showing an operation sequence of the electrode manufacturing system illustrated in FIG. 8;

FIG. 10 is a configuration view of an electrode drying apparatus and an electrode manufacturing system according to yet another embodiment of the present disclosure;

FIG. 11 is a configuration view of an electrode drying apparatus and an electrode manufacturing system according to yet another embodiment of the present disclosure; and

FIG. 12 is a configuration view of an electrode drying apparatus and an electrode manufacturing system according to yet another embodiment of the present disclosure.

### DETAILED DESCRIPTION OF EXEMPLARY EMBODIMENTS

Hereinafter, embodiments of the present disclosure will be described with reference to the drawings. However, this is merely exemplary, and the present disclosure is not limited to the exemplified specific embodiments.

### First, a secondary battery according to embodiments of the present disclosure will be described.

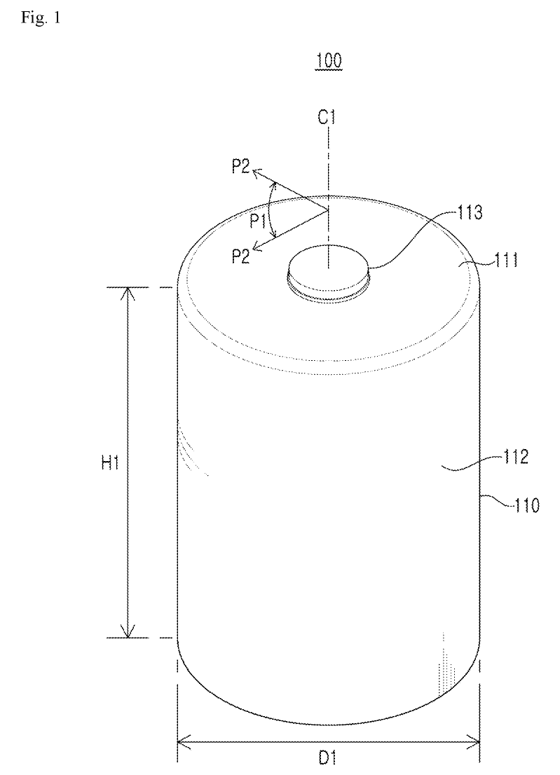

FIG. 1 is a schematic perspective view of a secondary battery according to one embodiment of the present disclosure.

For convenience, hereinafter, a rotational direction about a central axis C1 illustrated in FIG. 1 is referred to as a circumferential direction P1, an inward/outward direction toward/from the central axis C1 on a plane perpendicular to the central axis C1 is referred to as a radial direction P2, and an upward/downward direction along the central axis C1 is referred to as a vertical direction.

Referring to FIG. 1, in some embodiments, a secondary battery 100 may comprise an electrode manufactured by electrode manufacturing systems 200 and 500 according to embodiments of the present disclosure. In some embodiments, the secondary battery 100 may comprise an electrode assembly 120, and the electrode assembly 120 may comprise a first electrode 121 and a second electrode 122 disposed with a separator 123 interposed therebetween. The first electrode 121 and the second electrode 122 may be manufactured by the electrode manufacturing systems 200 and 500 according to embodiments of the present disclosure.

In some embodiments, the secondary battery 100 may comprise a can 110. The can 110 may have an internal space in which the electrode assembly 120 is accommodated. In some embodiments, the can 110 may be formed in a cylindrical shape, with an upper surface 111 and a side surface 112, and an open bottom. Although not illustrated, an opening at the bottom of the can 110 may be configured to be properly closed by a cap plate or the like.

In some embodiments, the upper surface 111 of the can 110 may comprise a rivet 113. The rivet 113 may function as one electrode terminal. For example, the rivet 113 may function as a positive electrode terminal. In the above, the remaining region of the can 110 excluding the rivet 113 may function as another electrode terminal corresponding to the rivet 113. For example, the remaining region of the upper surface 111 of the can 110 excluding the rivet 113 may function as a negative electrode terminal. In some embodiments, a gasket may be provided between the rivet 113 and the can 110 for electrical insulation and mechanical sealing.

In some embodiments, the can 110 may be provided in a cylindrical shape having a predetermined diameter D1 and height H1. In other words, the secondary battery 100 may be provided in a cylindrical shape having a predetermined diameter D1 and height H1. For example, the secondary battery 100 may have a diameter of 46 mm and a height of 80 mm. In some cases, the secondary battery 100 having such a form factor may be referred to as a ‘4680 battery.’ In another example, the secondary battery 100 may have a diameter of 46 mm and a height of 80 mm, a diameter of 46 mm and a height of 95 mm, or a diameter of 46 mm and a height of 110 mm. In some cases, the secondary battery 100 having such a form factor may be referred to as a ‘46xx battery,’ where ‘xx’ may represent the height of the corresponding form factor. In another example, the secondary battery 100 may have a diameter of 48 mm and a height of 75 mm, a diameter of 48 mm and a height of 80 mm, or a diameter of 48 mm and a height of 110 mm. In some cases, the secondary battery 100 having such a form factor may be referred to as a ‘48xx battery,’ where ‘xx’ may represent the height of the corresponding form factor. However, in the present disclosure, the diameter D1 and the height H1 of the secondary battery 100 may vary and are not necessarily limited to the above examples.

Meanwhile, although a cylindrical secondary battery 100 is exemplified in the present description, the form factor of the secondary battery 100 according to the embodiments of the present disclosure is not necessarily limited to the exemplified form factors. The secondary battery 100 according to the embodiments of the present disclosure may be implemented or applied in the form of a coin-type, prismatic-type, pouch-type, or other non-standardized types within the scope of the technical spirit described below.

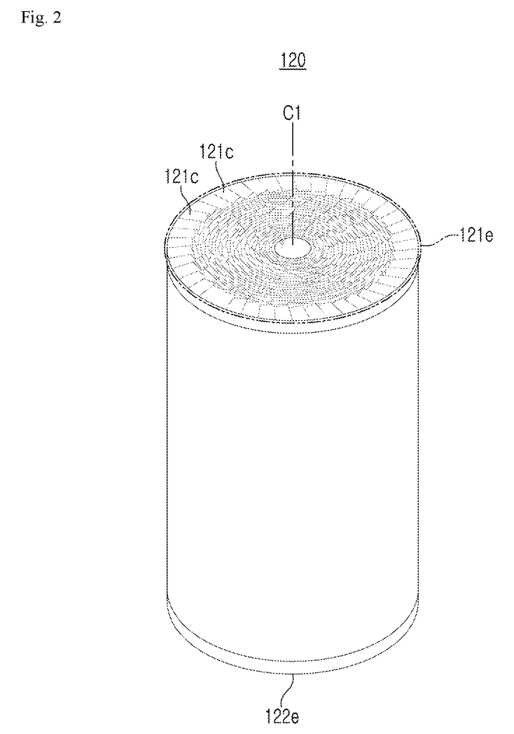

FIG. 2 is a schematic perspective view of an electrode assembly according to one embodiment of the present disclosure.

Referring to FIG. 2, in some embodiments, the secondary battery 100 may comprise the electrode assembly 120. The electrode assembly 120 may be accommodated inside the can 110 as described above. In some embodiments, the electrode assembly 120 may be wound about the central axis C1 and formed in a cylindrical roll shape. Such a roll-shaped electrode assembly 120 may be referred to as a jelly roll or the like in the art.

In some embodiments, the electrode assembly 120 may be provided with bonding surfaces 121e and 122e at one or both end portions in a direction of the central axis C1. That is, the electrode assembly 120 may be respectively provided with the bonding surfaces 121e and 122e at upper and/or lower portions. In the illustrated embodiment, the bonding surfaces 121e and 122e are respectively provided at the upper and lower portions of the electrode assembly 120. For convenience, hereinafter, the bonding surface 121e provided at the upper portion of the electrode assembly 120 is referred to as a first bonding surface 121e, and the bonding surface 122e provided at the lower portion of the electrode assembly 120 is referred to as a second bonding surface 122e.

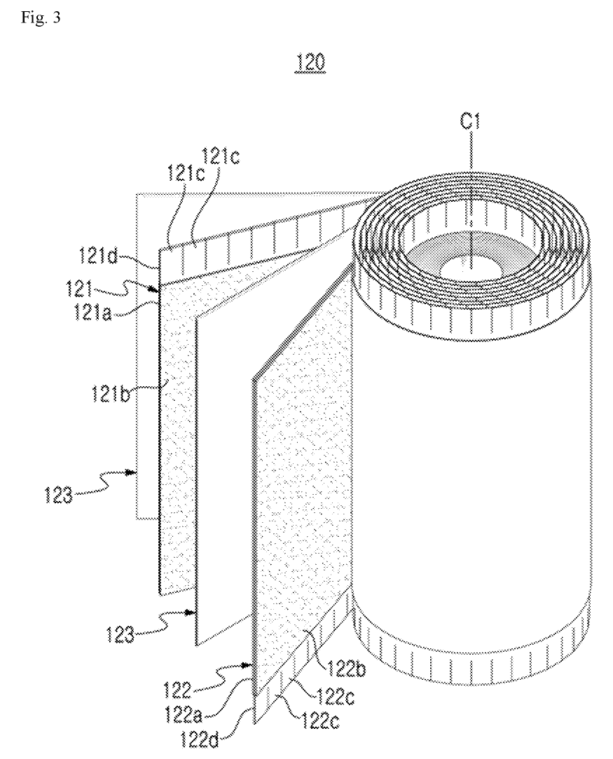

In the above, the bonding surfaces 121e and 122e may respectively comprise a plurality of electrode tabs 121c and 122c bent toward the central axis C1. That is, the first bonding surface 121e may comprise a plurality of first electrode tabs 121c bent toward the central axis C1 at the upper end of the electrode assembly 120, and the second bonding surface 122e may comprise a plurality of second electrode tabs 122c bent toward the central axis C1 at the lower end of the electrode assembly 120 (see FIG. 3). In other words, the first bonding surface 121e may be formed as an approximate surface defined by the plurality of bent first electrode tabs 121c, and the second bonding surface 122e may be formed as an approximate surface defined by the plurality of bent second electrode tabs 122c.

The secondary battery 100 as described above may have the plurality of electrode tabs 121c and 122c that respectively form the predetermined bonding surfaces 121e and 122e, which may be electrically connected to electrode terminals through the bonding surfaces 121e and 122e. That is, in the secondary battery 100, lead tabs may be omitted, and each bonding surface 121e and 122e may replace the function of the lead tabs. In some cases, such a secondary battery 100 may be referred to as a tabless battery or the like.

In some embodiments, each of the bonding surfaces 121e and 122e described above may be bonded to a current collector plate or a cap plate. For example, the first bonding surface 121e may be welded to a current collector plate at the upper end of the electrode assembly 120, and the second bonding surface 122e may be welded to another current collector plate at the lower end of the electrode assembly 120. As another example, the first bonding surface 121e may be welded to the current collector plate at the upper end of the electrode assembly 120, and the second bonding surface 122e may be welded to the cap plate at the lower end of the electrode assembly 120. Accordingly, each of the bonding surfaces 121e and 122e may be electrically connected to a current collector plate or a cap plate.

FIG. 3 is a schematic view illustrating the electrode assembly in FIG. 2 being wound around a central axis.

Referring to FIG. 3, in some embodiments, the electrode assembly 120 may be provided with the first electrode 121 and the second electrode 122 disposed with the separator 123 interposed therebetween. The first electrode 121 and/or the second electrode 122 may be electrodes manufactured by the electrode manufacturing systems 200 and 500. The separator 123 and the first and second electrodes 121 and 122 may be wound about the central axis C1. The first electrode 121 may function as a positive electrode or a negative electrode, and the second electrode 122 may function as a corresponding negative electrode or positive electrode. For convenience of description, the first electrode 121 is assumed to be a positive electrode, and the second electrode 122 is assumed to be a negative electrode.

In some embodiments, the first electrode 121 and the second electrode 122 may respectively comprise metal foils 121a and 122a wound about the central axis C1, active materials 121b and 122b provided on at least one surface of the metal foils 121a and 122a, and the plurality of electrode tabs 121c and 122c provided at one end region of the metal foils 121a and 122a in the direction of the central axis C1 and bent toward the central axis C1. For convenience, the metal foil 121a, the active material 121b, and the electrode tab 121c corresponding to the first electrode 121 are hereinafter referred to as a first metal foil 121a, a first active material 121b, and a first electrode tab 121c, respectively, and the metal foil 122a, the active material 122b, and the electrode tab 122c corresponding to the second electrode 122 are hereinafter referred to as a second metal foil 122a, a second active material 122b, and a second electrode tab 122c, respectively.

In some embodiments, the first electrode 121 may comprise the first metal foil 121a. For example, the first metal foil 121a may comprise aluminum, stainless steel, nickel, titanium, an alloy thereof, and the like. The first electrode 121 may also comprise the first active material 121b provided on at least one surface of the first metal foil 121a. In some embodiments, the first active material 121b may comprise a compound capable of reversibly intercalating and deintercalating lithium ions. For example, the first active material 121b may comprise a lithium–nickel metal oxide, and in some cases, the lithium–nickel metal oxide may further comprise cobalt, manganese, aluminum, and the like.

Similar to the above, in some embodiments, the second electrode 122 may comprise the second metal foil 122a. For example, the second metal foil 122a may comprise copper, stainless steel, nickel, titanium, an alloy thereof, and the like. The second electrode 122 may also comprise the second active material 122b provided on at least one surface of the second metal foil 122a. In some embodiments, the second active material 122b may comprise a compound capable of reversibly intercalating and deintercalating lithium ions. For example, the second active material 122b may comprise a carbon-based material such as crystalline carbon, amorphous carbon, a carbon composite, a carbon fiber, or the like. Alternatively, the second active material 122b may comprise lithium metal, a lithium alloy, a silicon-containing material, a tin-containing material, or the like.

The separator 123 may be provided between the first electrode 121 and the second electrode 122. The separator 123 may be provided to prevent an electrical short circuit between the first and second electrodes 121 and 122 and allow the flow of ions. In some embodiments, the separator 123 may comprise a porous polymer film, a porous nonwoven fabric, or the like. For example, the porous polymer film may comprise a polyolefin-based polymer such as an ethylene polymer, a propylene polymer, an ethylene/butene copolymer, an ethylene/hexene copolymer, or an ethylene/methacrylate copolymer. In addition, the porous nonwoven fabric may comprise high–melting-point glass fibers, polyethylene terephthalate (PET) fibers, or the like.

Meanwhile, in some embodiments, the first electrode 121 may comprise the first electrode tab 121c. In the illustrated embodiment, the first electrode tab 121c is provided at the upper portion of the first electrode 121. As described above, a plurality of first electrode tabs 121c may be provided, and the plurality of first electrode tabs 121c may be disposed in a direction in which the first electrode 121 is wound. In addition, the first electrode tab 121c may be provided at an upper region of the first metal foil 121a in which the application of the first active material 121b is omitted. In other words, the first electrode 121 may comprise a first uncoated portion 121d in which the application of the first active material 121b is omitted, and the first electrode tab 121c may be provided at the first uncoated portion 121d.

Similar to the above, in some embodiments, the second electrode 122 may comprise the second electrode tab 122c. In the illustrated embodiment, the second electrode tab 122c is provided at the lower portion of the second electrode 122. The second electrode tab 122c may be provided at a second uncoated portion 122d, in which the application of the second active material 122b is omitted, and a plurality of second electrode tabs 122c may be provided.

Meanwhile, the separator 123 may be provided between the first electrode 121 and the second electrode 122 as described above. In some embodiments, an upper portion of the separator 123 may be disposed between the first electrode tab 121c and an upper end of the second electrode 122. The upper portion of the separator 123 may function to electrically insulate between the first electrode tab 121c and the second electrode 122. Similarly, a lower portion of the separator 123 may be disposed between a lower end of the first electrode 121 and the second electrode tab 122c. The lower portion of the separator 123 may function to electrically insulate between the first electrode 121 and the second electrode tab 122c.

Next, an electrode drying apparatus and an electrode manufacturing system comprising the same according to embodiments of the present disclosure will be described.

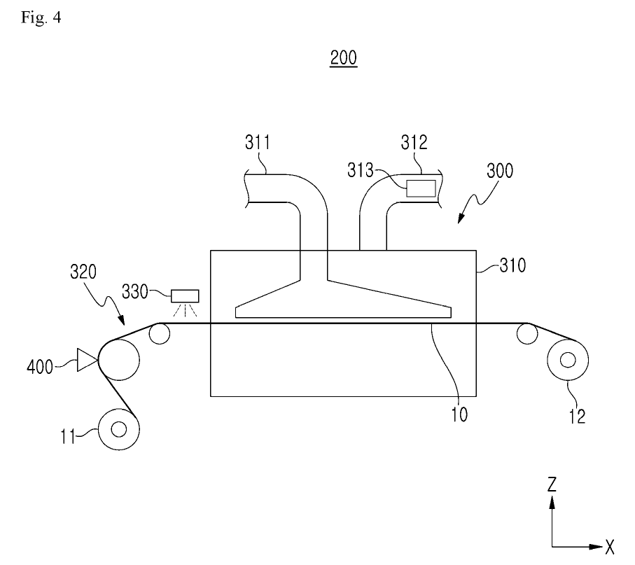

FIG. 4 is a configuration view of an electrode drying apparatus and an electrode manufacturing system according to one embodiment of the present disclosure.

For convenience, as illustrated in FIG. 4, a direction in which the metal foil 10 is transferred by a transfer device 320 within a drying chamber 310 is hereinafter referred to as an X-direction, and a direction in which one surface and the other surface of the metal foil 10 face is referred to as a Z-direction.

Referring to FIG. 4, in some embodiments, an electrode drying apparatus 300 may comprise the drying chamber 310 provided with an air supply duct 311 and an exhaust duct 312, the transfer device 320 configured to transfer the metal foil 10 into the drying chamber 310, and a moisture supply device 330 configured to supply moisture to the metal foil 10 transferred into the drying chamber 310.

In addition, in some embodiments, an electrode manufacturing system 200 may comprise the electrode drying apparatus 300 and a die 400 configured to apply a slurry to the metal foil 10.

In some embodiments, the metal foil 10 may be unwound from a first roll 11 by the transfer device 320, transferred by a roller, and wound onto a second roll 12 after passing through the drying chamber 310. The transfer device 320 may comprise a plurality of rollers and a driving unit (e.g., a motor) for rotating the rollers. Along a transfer direction of the metal foil 10, the die 400 may apply a slurry, which is prepared by mixing an active material, a polymer binder, and a conductive material in a solvent, onto one surface of the metal foil 10 at a position upstream of the drying chamber 310. The metal foil 10 having the slurry applied to one surface may be transferred by the transfer device 320 and supplied to the drying chamber 310. The drying chamber 310 may comprise the air supply duct 311 and the exhaust duct 312, and the slurry may be dried by hot air supplied from the air supply duct 311. The hot air used for drying the slurry may be discharged to the outside through the exhaust duct 312.

In some embodiments, the moisture supplied to the metal foil 10 by the moisture supply device 330 may be transferred into the drying chamber 310 and vaporized inside the drying chamber 310 by the hot air supplied from the air supply duct 311. That is, the humidity inside the drying chamber 310 may be increased by the moisture supplied from the moisture supply device 330, and the moisture in the drying chamber 310 may become saturated. The moisture supply device 330 may be connected to, for example, a storage tank (not illustrated) to be supplied with moisture.

In some embodiments, the moisture supply device 330 may be provided outside the drying chamber 310. The drying chamber 310 may be provided with an inlet through which the metal foil 10 enters, and the moisture supply device 330 may be located adjacent to the inlet of the drying chamber 310. The moisture supply device 330 may be located adjacent to the inlet of the drying chamber 310 to supply moisture onto the metal foil 10 as the metal foil 10 enters the drying chamber 310.

In some embodiments, the moisture supply device 330 may spray moisture onto the metal foil 10. In some embodiments, the moisture supply device 330 may comprise one or more nozzles for spraying moisture. The sprayed moisture may be supplied to the metal foil 10 in the form of a mist. As moisture is sprayed onto the metal foil 10 in the form of a mist, the moisture on the metal foil 10 may rapidly vaporize, and the humidity inside the drying chamber 310 may rapidly increase. As will be described below, drying of the slurry may proceed after the inside of the drying chamber 310 becomes saturated. As the moisture supply device 330 sprays the moisture, the internal humidity of the drying chamber 310 may quickly increase, and the entire process may be performed more rapidly.

In some embodiments, drying of the slurry may proceed after the drying chamber 310 becomes saturated by the moisture supplied to the metal foil 10 from the moisture supply device 330 and vaporized inside the drying chamber 310.

In general, process parameters of the drying chamber 310 for drying the slurry (for example, a drying temperature and an air flow rate of air supplied through the air supply duct 311) may be set based on a saturated state of the inside of the drying chamber 310 in order to perform drying under consistent conditions. In other words, humidity in the drying chamber 310, which is not yet saturated with moisture, may increase as the slurry is dried, and as the drying continues, the saturated state may be maintained. Therefore, by setting the process parameters of the drying chamber 310 based on the saturated state of the inside of the drying chamber 310, the slurry may be dried under consistent conditions.

However, during the initial drying process, the inside of the drying chamber 310 is in an unsaturated state, and as drying progresses, the inside of the drying chamber 310 may become saturated as the solvent in the slurry vaporizes. However, in this method, since humidity in the drying chamber 310 is still low at the initial stage of the process before the drying chamber 310 becomes saturated, performing drying with process parameters based on the saturated state may cause the slurry to be overdried. An overdried slurry may cause cracks or breakage in an electrode during a process in which the electrode is wound onto a roll, which may degrade performance of the secondary battery even when the electrode is wound, making application to an actual product difficult. In other words, the above method requires additional work such as discarding defective electrodes and results in the loss of slurry.

The initial temperature of the drying chamber 310 may be set low to prevent overdrying of the slurry. However, in this method, since process parameters should be programmed to be set differently over time for a plurality of drying chambers 310 according to the electrode composition, and the process parameters should also be configured to be linked in real time the with internal humidity of the drying chambers 310, there is a problem of high operational difficulty and low work efficiency.

However, according to the present disclosure, the interior of the drying chamber 310 becomes saturated as the moisture supplied from the moisture supply device 330 is vaporized, rather than the solvent in the slurry, thereby preventing overdrying of the slurry during the initial drying process. In addition, the amount of moisture required for internal saturation of the drying chamber 310 is constant. Although the degree of evaporation of the slurry solvent required to provide the necessary amount of moisture is difficult to measure, the amount of moisture supplied from the moisture supply device 330 may be easily adjusted, making the process simpler. Accordingly, slurry loss may be reduced, and work efficiency may be improved.

In some embodiments, a humidity sensor 313 may be provided to sense humidity inside the drying chamber 310. The structure or method of the humidity sensor 313 is not particularly limited, but the humidity sensor 313 may, for example, be a capacitive humidity sensor that comprises a moisture-sensitive layer that detects humidity and utilizes a change in an electrical signal when the moisture-sensitive layer is exposed to moisture. The moisture saturation state inside the drying chamber 310 may be monitored by the humidity sensor 313. When moisture inside the drying chamber 310 becomes saturated, the moisture supply device 330 may stop operating, no further moisture may be supplied onto the metal foil 10, and the die 400 may begin applying a slurry onto the metal foil 10.

In some embodiments, the humidity sensor 313 may be provided inside the exhaust duct 312.The humidity sensor 313 may sense humidity inside the drying chamber 310 from the air that is exhausted from the drying chamber 310 through the exhaust duct 312.

In some embodiments, a moisture spray amount and/or a spray time of the moisture supply device 330 may be adjusted according to humidity inside the drying chamber 310. As described above, depending on the humidity inside the drying chamber 310 monitored by the humidity sensor 313, the moisture spray amount and/or the spray time of the moisture supply device 330 may be increased or decreased. For example, when the humidity inside the drying chamber 310 increases rapidly, the moisture spray amount and/or the spray time may be decreased. Alternatively, when the humidity inside the drying chamber 310 increases slowly, the moisture spray amount and/or the spray time may be increased.

In some embodiments, the moisture supply device 330 may supply moisture into the drying chamber 310 before the die 400 applies a slurry to the metal foil 10. More specifically, the metal foil 10 may begin to be transferred by the transfer device 320 before a slurry is applied to the metal foil 10, and the moisture supply device 330 may supply moisture onto the metal foil 10 on which a slurry is not applied. The moisture supplied from the moisture supply device 330 may be transferred into the drying chamber 310 together with the metal foil 10. The transferred moisture may be vaporized by hot air, thereby increasing the humidity inside the drying chamber 310 and allowing the moisture to become saturated. After the moisture inside the drying chamber 310 becomes saturated, the moisture supply device 330 may stop operating.

In some embodiments, the die 400 may apply a slurry onto the metal foil 10 after the moisture inside the drying chamber 310 becomes saturated. More specifically, as the moisture supplied onto the metal foil 10 on which the slurry is not applied vaporizes inside the drying chamber 310, the humidity inside the drying chamber 310 increases, and after the moisture becomes saturated, the die 400 may apply a slurry onto the metal foil 10. As described above, the moisture saturation state inside the drying chamber 310 may be monitored by the humidity sensor 313. The slurry applied onto the metal foil 10 may be transferred into the drying chamber 310 in a moisture-saturated state and may be dried. Accordingly, the slurry may be prevented from being overdried.

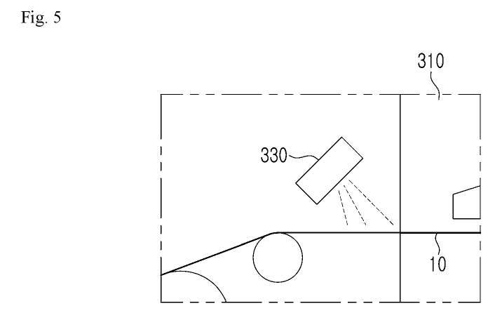

FIG. 5 is a partially enlarged view of an electrode drying apparatus and an electrode manufacturing system according to another embodiment of the present disclosure.

Referring to FIG. 5, in some embodiments, a moisture supply device 330 may spray moisture onto a metal foil 10 in an inclined direction in a transfer direction of the metal foil 10. That is, the moisture supply device 330, which supplies moisture onto the metal foil 10 from an upper side in the Z-direction, may spray the moisture in an inclined direction in the X-direction. By spraying moisture in an inclined direction in the transfer direction of the metal foil 10, the moisture supply device 330 may allow moisture to be smoothly supplied into the drying chamber 310.

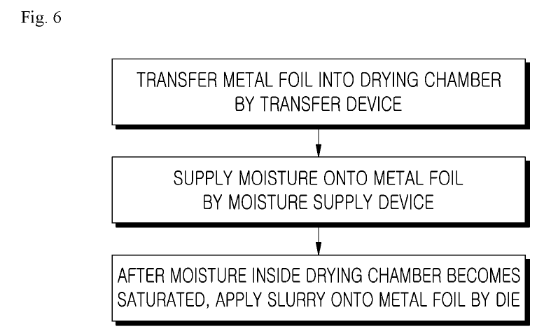

FIG. 6 is a flowchart showing an operation sequence of the electrode manufacturing system illustrated in FIG. 4.

Referring to FIG. 6, the electrode manufacturing system 200 according to the present disclosure may operate through a process comprising an operation in which the transfer device 320 transfers the metal foil 10 into the drying chamber 310, an operation in which the moisture supply device 330 supplies moisture onto the metal foil 10, and an operation in which the die 400 applies a slurry onto the metal foil 10 after the moisture inside the drying chamber 310 becomes saturated.

First, the metal foil 10 may be transferred into the drying chamber 310 by the transfer device 320. The metal foil 10 on which the slurry is not applied from the die 400 may be transferred into the drying chamber 310. The metal foil 10 may be unwound from the first roll 11, pass through the drying chamber 310, and wound onto the second roll 12.

Then, the moisture supply device 330 may supply moisture onto the metal foil 10. The moisture supply device 330 may spray moisture onto the metal foil 10. By spraying, moisture may be supplied onto the metal foil 10 in the form of a mist and may be rapidly vaporized by hot air inside the drying chamber 310.

Then, after the moisture inside the drying chamber 310 becomes saturated, the die 400 may apply the slurry onto the metal foil 10. The humidity inside the drying chamber 310 may be monitored by the humidity sensor 313, and when the moisture inside the drying chamber 310 is confirmed to be saturated, the die 400 may apply the slurry onto the metal foil 10. Since the slurry is supplied into the drying chamber 310 in a moisture-saturated state, the slurry may be prevented from being overdried, and the loss of slurry may be reduced.

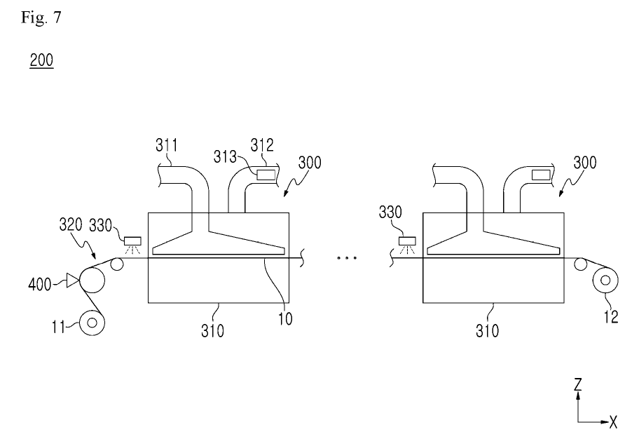

FIG. 7 is a configuration view of an electrode drying apparatus and an electrode manufacturing system according to still another embodiment of the present disclosure.

Referring to FIG. 7, in some embodiments, a plurality of drying chambers 310 may be disposed in a transfer direction of the metal foil 10. More specifically, between the first roll 11 and the second roll 12, the plurality of drying chambers 310 may be disposed in an X-direction. Each of the drying chambers 310 may be provided with a moisture supply device 330 for supplying moisture to the corresponding drying chamber 310 and a humidity sensor 313 for sensing the humidity inside the corresponding drying chamber 310. In some embodiments, a die 400 may apply a slurry onto the metal foil 10 after all of the drying chambers 310 become saturated with moisture. Alternatively, in some embodiments, the die 400 may begin applying the slurry onto the metal foil 10 after moisture in a first drying chamber 310 in the transfer direction of the metal foil 10 becomes saturated. However, the drying chambers 310 after the first drying chamber 310 may become saturated before the slurry enters the corresponding drying chambers 310.

The plurality of drying chambers 310 may dry the slurry under different process parameters. For example, a drying temperature of the slurry may gradually increase in the X-direction. In the first drying chamber 310, the slurry may be dried at the lowest temperature, and in the last drying chamber 310, the slurry may be dried at the highest temperature. The process parameters of each drying chamber 310 may be appropriately adjusted according to a drying state of the slurry.

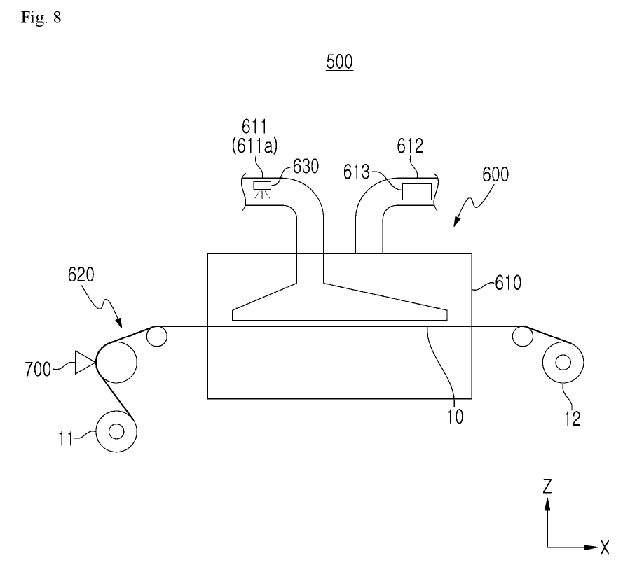

FIG. 8 is a configuration view of an electrode drying apparatus and an electrode manufacturing system according to yet another embodiment of the present disclosure. Hereinafter, the same elements as those in the above-described embodiments will be briefly described and differences will be emphasized.

Referring to FIG. 8, in some embodiments, an electrode drying apparatus 600 may comprise a drying chamber 610 comprising an air supply duct 611 and an exhaust duct 612, a transfer device 620 configured to transfer a metal foil 10 into the drying chamber 610, and a moisture supply device 630 provided inside the air supply duct 611 and configured to supply moisture to the air supplied into the drying chamber 610.

In addition, in some embodiments, an electrode manufacturing system 500 may comprise the electrode drying apparatus 600 and a die 700 configured to apply a slurry onto the metal foil 10.

In some embodiments, the metal foil 10 may be unwound from the first roll 11 by the transfer device 620, transferred by rollers, and wound onto the second roll 12 after passing through the drying chamber 610. In the transfer direction of the metal foil 10, the die 700 may apply a slurry, which is prepared by mixing an active material, a polymer binder, and a conductive material in a solvent, onto one surface of the metal foil 10 at a position upstream of the drying chamber 610.The drying chamber 610 may comprise the air supply duct 611 and the exhaust duct 612, and the slurry may be dried by the hot air supplied from the air supply duct 611. The hot air used to dry the slurry may be discharged to the outside through the exhaust duct 612.

In some embodiments, the moisture supply device 630 may supply moisture into the air supply duct 611, and the supplied moisture may flow into the drying chamber 610 together with hot air from the air supply duct 611. The introduced moisture may be vaporized inside the drying chamber 610 by the hot air. That is, the humidity inside the drying chamber 610 may increase and moisture may become saturated by the moisture supplied from the moisture supply device 630.

In some embodiments, the moisture supply device 630 may be provided at the inner side of an end portion of the air supply duct 611 connected to the drying chamber 610 inside the air supply duct 611. Accordingly, moisture supplied from the moisture supply device 630 may be uniformly diffused inside the air supply duct 611 and then may flow into the drying chamber 610 by the hot air in the air supply duct 611.

In some embodiments, the moisture supply device 630 may spray moisture into the air supply duct 611. In some embodiments, the moisture supply device 630 may comprise one or more nozzles for spraying moisture. The sprayed moisture may be supplied into the air supply duct 611 in the form of a mist. The moisture sprayed in the form of a mist may easily flow into the drying chamber 610 by the hot air from the air supply duct 611. In addition, the moisture sprayed in the form of a mist may rapidly vaporize inside the drying chamber 610, which rapidly increases the humidity inside the drying chamber 610. That is, as the moisture supply device 630 sprays the moisture, the internal humidity of the drying chamber 610 may rapidly increase, and the entire process may be performed more rapidly. In some embodiments, the moisture supply device 630 may spray moisture in an inclined direction in the transfer direction of the metal foil 10.

In some embodiments, drying of the slurry may proceed after the drying chamber 610 becomes saturated by the moisture supplied from the moisture supply device 630 to the air supply duct 611 and vaporized inside the drying chamber 610. Accordingly, overdrying of the slurry may be prevented, slurry loss may be reduced, and work efficiency may be improved.

In some embodiments, a humidity sensor 613 may be provided to sense the humidity inside the drying chamber 610. When the moisture inside the drying chamber 610 becomes saturated, the moisture supply device 630 may stop operating, no further moisture may be supplied into the air supply duct 611, and the die 700 may begin applying a slurry onto the metal foil 10. In some embodiments, the humidity sensor 613 may be provided inside the exhaust duct 612.

In some embodiments, a moisture spray amount and/or a spray time of the moisture supply device 630 may be adjusted according to the humidity inside the drying chamber 610. Depending on the humidity inside the drying chamber 610 monitored by the humidity sensor 613, the moisture spray amount and/or the spray time of the moisture supply device 630 may be increased or decreased.

In some embodiments, the moisture supply device 630 may supply moisture into the drying chamber 610 before the die 700 applies a slurry onto the metal foil 10. More specifically, before a slurry is applied onto the metal foil 10, the metal foil 10 may begin to be transferred by the transfer device 620, and the moisture supply device 630 may supply moisture into the air supply duct 611. The moisture supplied from the moisture supply device 630 may be transferred into the drying chamber 610 together with hot air from the air supply duct 611. The transferred moisture may be vaporized by the hot air, thereby increasing the humidity inside the drying chamber 610 and allowing the moisture to become saturated. After the moisture inside the drying chamber 610 becomes saturated, the moisture supply device 630 may stop operating.

In some embodiments, the die 700 may apply a slurry onto the metal foil 10 after the moisture inside the drying chamber 610 becomes saturated. More specifically, as the moisture supplied onto the metal foil 10 on which a slurry has not been applied vaporizes inside the drying chamber 610, the humidity inside the drying chamber 610 increases, and after the moisture becomes saturated, the die 700 may apply a slurry onto the metal foil 10. As described above, the moisture saturation state inside the drying chamber 610 may be monitored by the humidity sensor 613. The slurry applied onto the metal foil 10 may be transferred into the drying chamber 610 in a moisture-saturated state and may be dried. Accordingly, the slurry may be prevented from being overdried.

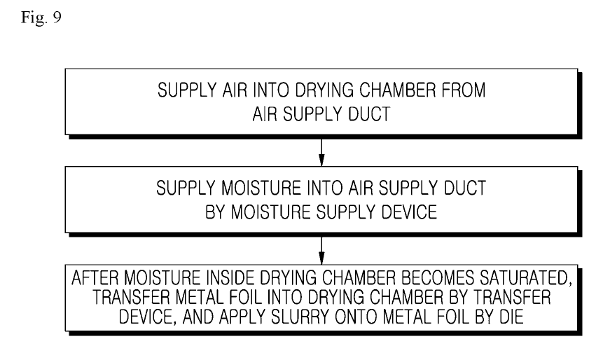

FIG. 9 is a flowchart showing an operation sequence of the electrode manufacturing system illustrated in FIG. 8.

Referring to FIG. 9, the electrode manufacturing system 500 according to the present disclosure may operate through a process comprising an operation in which air is supplied from the air supply duct 611 into the drying chamber 610, an operation in which the moisture supply device 630 supplies moisture into the air supply duct 611, and an operation in which the die 700 applies a slurry onto the metal foil 10 after the moisture inside the drying chamber 610 becomes saturated.

First, air may be supplied from the air supply duct 611 into the drying chamber 610. The supplied air may be hot air and may be used for vaporizing the moisture supplied from the moisture supply device 630 and drying the slurry.

Then, the moisture supply device 630 may supply moisture into the air supply duct 611. The moisture supply device 630 may spray moisture into the air supply duct 611. By spraying, moisture may be supplied into the air supply duct 611 in the form of a mist and may be rapidly vaporized by hot air inside the drying chamber 610.

Then, after the moisture inside the drying chamber 610 becomes saturated, the transfer device 620 may transfer the metal foil 10 into the drying chamber 610, and the die 700 may apply the slurry onto the metal foil 10. The humidity inside the drying chamber 610 may be monitored by the humidity sensor 613, and when the moisture inside the drying chamber 610 is confirmed to be saturated, the transfer device 620 may transfer the metal foil 10, and the die 700 may apply the slurry onto the metal foil 10. Since the slurry is supplied into the drying chamber 610 in a moisture-saturated state, the slurry may be prevented from being overdried, and slurry loss may be reduced.

Meanwhile, in some embodiments, the air supply duct 611 may comprise an upper air supply duct 611a connected to an upper portion of the drying chamber 610, and the moisture supply device 630 may be provided in the upper air supply duct 611a. As illustrated in FIG. 8, the upper air supply duct 611a may be connected to the upper portion of the drying chamber 610, that is, an upper portion in the Z-direction. The upper air supply duct 611a may be provided to face one surface of the metal foil 10 to which the slurry from the die 700 is applied. The moisture supply device 630 provided in the upper air supply duct 611a may lower the temperature of the hot air by supplying moisture into the upper air supply duct 611a. That is, when the moisture inside the drying chamber 610 becomes saturated and the application and drying of the slurry are in progress, when the temperature of the hot air supplied from the upper air supply duct 611a becomes excessively high and overdrying of the slurry is a concern, the temperature of the hot air may be lowered by the moisture supplied from the moisture supply device 630. When an immediate reduction in the temperature of the hot air in the upper air supply duct 611a is difficult, the overdrying of the slurry may be prevented using the moisture supply device 630.

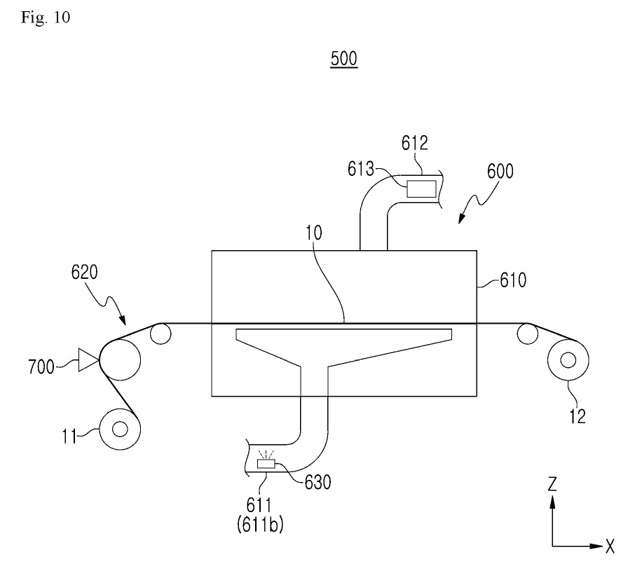

FIG. 10 is a configuration view of an electrode drying apparatus and an electrode manufacturing system according to yet another embodiment of the present disclosure.

Referring to FIG. 10, in some embodiments, the air supply duct 611 may comprise a lower air supply duct 611b connected to a lower portion of the drying chamber 610, and the moisture supply device 630 may be provided in the lower air supply duct 611b. The lower air supply duct 611b may be connected to the lower portion of the drying chamber 610, that is, a lower portion in the Z-direction. The lower air supply duct 611b may be provided to face the other surface of the metal foil 10, which is opposite the surface onto which the slurry from the die 700 is applied. Since the hot air from the lower air supply duct 611b is not directly supplied to the slurry being dried, overdrying of the slurry may be prevented. Similarly, the temperature of the hot air may be reduced using the moisture supply device 630 provided in the lower air supply duct 611b.

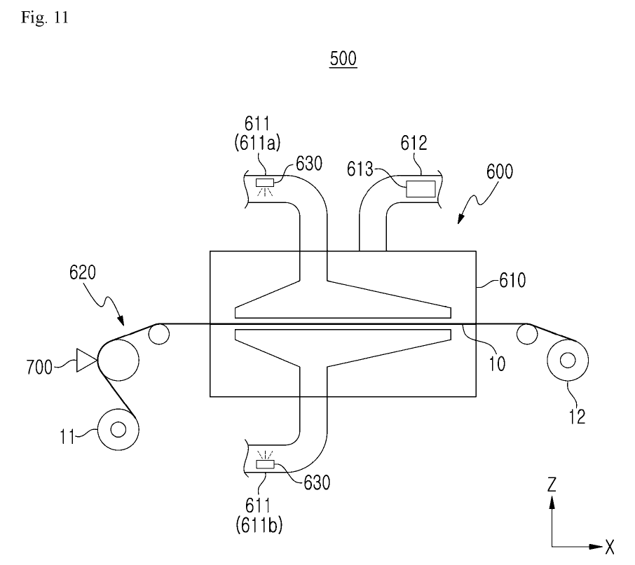

FIG. 11 is a configuration view of an electrode drying apparatus and an electrode manufacturing system according to yet another embodiment of the present disclosure.

Referring to FIG. 11, in some embodiments, the air supply duct 611 may comprise an upper air supply duct 611a connected to the upper portion of the drying chamber 610 and a lower air supply duct 611b connected to the lower portion of the drying chamber 610, and the moisture supply device 630 may be provided in the upper air supply duct 611a and/or the lower air supply duct 611b. FIG. 11 illustrates an embodiment in which the moisture supply device 630 is provided in both the upper air supply duct 611a and the lower air supply duct 611b. Similarly, the temperature of the hot air supplied from the air supply duct provided with the moisture supply device 630 may be reduced by the moisture supplied from the moisture supply device 630.

In some embodiments, the upper air supply duct 611a and the lower air supply duct 611b may branch from a single duct. In such a case, since hot air under the same conditions is supplied to both air supply ducts, it may be difficult to independently control the temperature. However, the hot air supplied from an air supply duct provided with the moisture supply device 630 may have its temperature reduced by moisture, thereby enabling the temperatures of hot air supplied through the upper air supply duct 611a and the lower air supply duct 611b to be differently controlled. For example, when the moisture supply device 630 is provided in the lower air supply duct 611b, hot air at a lower temperature than that from the upper air supply duct 611a may be supplied through the lower air supply duct 611b as the moisture supply device 630 supplies moisture.

In some embodiments, since the metal foil of the electrode may be provided with the active material on at least one of one surface and the other surface, the other surface of the metal foil 10, on which a slurry is applied to one surface, may or may not be provided with a pre-dried slurry. When a slurry is applied and dried on one surface of the metal foil provided with the pre-dried slurry on the other surface, the pre-dried slurry on the other surface may be transferred back into the drying chamber. To prevent the pre-dried slurry from being overdried inside the drying chamber, the moisture supply device 630 may be used. That is, by providing the moisture supply device 630 in the lower air supply duct 611b and supplying moisture, hot air at a lower temperature than that from the upper air supply duct 611a may be supplied toward the other surface of the metal foil. Accordingly, the pre-dried slurry provided on the other surface of the metal foil may be prevented from being overdried.

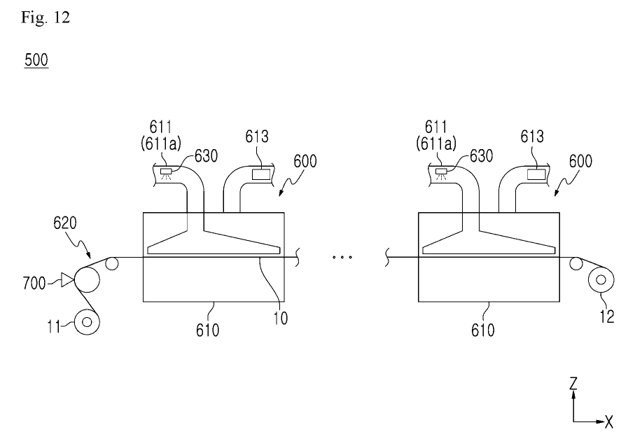

FIG. 12 is a configuration view of an electrode drying apparatus and an electrode manufacturing system according to yet another embodiment of the present disclosure.

Referring to FIG. 12, in some embodiments, a plurality of drying chambers 610 may be disposed along a transfer direction of the metal foil 10. Although FIG. 12 shows an embodiment in which each drying chamber 610 comprises only the upper air supply duct 611a, each drying chamber 610 may comprise the upper air supply duct 611a and/or the lower air supply duct 611b. In addition, the structure in which the air supply duct is provided in each drying chamber 610 may or may not be the same.

Each drying chamber 610 may be provided with the moisture supply device 630 for supplying moisture to the corresponding drying chamber 610 and the humidity sensor 613 for sensing the humidity inside the corresponding drying chamber 610. In some embodiments, the die 700 may apply a slurry onto the metal foil 10 after all of the drying chambers 610 become saturated with moisture. Alternatively, in some embodiments, the die 700 may apply the slurry onto the metal foil 10 after moisture in a first drying chamber 610 in the transfer direction of the metal foil 10 becomes saturated. However, the drying chambers 610 after the first drying chamber 610 may become saturated before the slurry enters the corresponding drying chambers 610.

The plurality of drying chambers 610 may dry the slurry under different process parameters. For example, the temperature of the drying chamber 610 in which the slurry is dried may gradually increase in the X-direction. In the first drying chamber 610, the slurry may be dried at the lowest temperature, and in the last drying chamber 610, the slurry may be dried at the highest temperature. The process parameters of each drying chamber 610 may be appropriately adjusted according to a drying state of the slurry.

According to the electrode drying apparatus and the electrode manufacturing system having such a structure, overdrying of the slurry occurring during the initial drying process of an electrode may be prevented.

In addition, since initial process parameter adjustment for preventing overdrying of a slurry is unnecessary, work efficiency may be improved.

Furthermore, since a process for discarding an overdried slurry may be omitted, work efficiency may be further improved.

Some embodiments of the present disclosure can provide an electrode drying apparatus and an electrode manufacturing system.

In addition, some embodiments of the present disclosure can provide an electrode drying apparatus and an electrode manufacturing system capable of preventing overdrying of a slurry.

In addition, some embodiments of the present disclosure can provide an electrode drying apparatus and an electrode manufacturing system capable of minimizing slurry loss.

In addition, some embodiments of the present disclosure can provide an electrode drying apparatus and an electrode manufacturing system capable of improving work efficiency.

The above description is merely an example of applying the principles of the present disclosure, and other configurations may be further comprised without departing from the scope of the present disclosure.

What is claimed is:

1. An electrode drying apparatus comprising:
a drying chamber provided with an air supply duct and an exhaust duct;
a transfer device configured to transfer a metal foil into the drying chamber; and
a moisture supply device configured to supply moisture to the metal foil transferred into the drying chamber.

2. The electrode drying apparatus of claim 1, wherein the moisture supply device sprays moisture onto the metal foil.

3. The electrode drying apparatus of claim 1, comprising a humidity sensor configured to sense humidity inside the drying chamber.

4. The electrode drying apparatus of claim 3, wherein one or more of a moisture spray amount and a spray time of the moisture supply device are adjusted according to the humidity inside the drying chamber.

5. An electrode drying apparatus comprising:
a drying chamber provided with an air supply duct and an exhaust duct;
a transfer device configured to transfer a metal foil into the drying chamber; and
a moisture supply device provided inside the air supply duct to supply moisture to air supplied into the drying chamber.

6. The electrode drying apparatus of claim 5, wherein the moisture supply device sprays moisture into the air supply duct.

7. The electrode drying apparatus of claim 5, comprising a humidity sensor configured to sense humidity inside the drying chamber.

8. The electrode drying apparatus of claim 7, wherein the moisture supply device adjusts one or more of a moisture spray amount and a spray time according to the humidity inside the drying chamber.

9. The electrode drying apparatus of claim 5, wherein the air supply duct comprises an upper air supply duct connected to an upper portion of the drying chamber, and the moisture supply device is provided in the upper air supply duct.

10. The electrode drying apparatus of claim 5, wherein the air supply duct comprises a lower air supply duct connected to a lower portion of the drying chamber, and
the moisture supply device is provided in the lower air supply duct.

11. The electrode drying apparatus of claim 5, wherein the air supply duct comprises an upper air supply duct connected to an upper portion of the drying chamber and a lower air supply duct connected to a lower portion of the drying chamber, and
the moisture supply device is provided in one or more of the upper air supply duct and the lower air supply duct.

12. An electrode manufacturing system comprising:
the electrode drying apparatus of claim 1; and
a die configured to apply slurry onto the metal foil.

13. The electrode manufacturing system of claim 12, wherein the moisture supply device supplies moisture into the drying chamber before the die applies the slurry onto the metal foil.

14. The electrode manufacturing system of claim 12, wherein the die applies the slurry onto the metal foil after moisture inside the drying chamber is saturated.

15. The electrode manufacturing system of claim 12, wherein a plurality of drying chambers are disposed in a transfer direction of the metal foil.
